(19) United States
(12) Patent Application Publication
(10) Pub. No.: US 2018/0255153 A1
(43) Pub. Date: Sep. 6, 2018

(54) INFORMATION PROCESSING APPARATUS AND INFORMATION PROCESSING SYSTEM

(71) Applicant: FUJITSU LIMITED, Kawasaki-shi (JP)

(72) Inventor: Ohki Koizumi, Shinagawa (JP)

(73) Assignee: FUJITSU LIMITED, Kawasaki-shi (JP)

(21) Appl. No.: 15/897,192

(22) Filed: Feb. 15, 2018

(30) Foreign Application Priority Data
Mar. 1, 2017 (JP) 2017-037833

(51) Int. Cl. H04L 29/08; H04L 29/06

(52) U.S. Cl. CPC H04L 67/28; H04L 61/1511; H04L 63/0281; H04L 63/0876

(57) ABSTRACT

An information processing apparatus is provided between a terminal device which belongs to a first network and a proxy device which belongs to the first network and relays communication between the first network and a second network. The information processing apparatus includes a memory and a processor coupled to the memory and configured to respond a virtual address having the information processing apparatus as a reception destination to the terminal device upon receiving a name resolution request related to a domain in the second network and transmitted from the terminal device; and access an access destination designated by an access request in the domain corresponding to the virtual address via the proxy device when the access request transmitted to the virtual address is received from the terminal device.

### CROSS-REFERENCE TO RELATED APPLICATION

This application is based upon and claims the benefit of priority of the prior Japanese Patent Application No. 2017-037833, filed on Mar. 1, 2017, the entire contents of which are incorporated herein by reference.

### FIELD

The embodiments discussed herein are related to an information processing apparatus, an information processing system, and a non-transitory computer-readable recording medium having stored therein a program for causing a computer to execute an information processing method.

### BACKGROUND

In an internal network such as in-company network, in some cases, a computer belonging to an internal network accesses an external network such as the Internet via a proxy server according to a security policy.

Hereinafter, an access method for requesting proxy access to the proxy server is referred to as “proxy access” and a network environment premised on the proxy access is referred to as a “proxy environment”.

Related technologies are disclosed in, for example, Japanese Laid-Open Patent Publication No. 2002-351733 and Japanese Laid-Open Patent Publication No. 09-325931.

### SUMMARY

According to an aspect of the embodiments, an information processing apparatus is provided between a terminal device which belongs to a first network and a proxy device which belongs to the first network and relays communication between the first network and a second network. The information processing apparatus includes a memory and a processor coupled to the memory and configured to provide a virtual address having the information processing apparatus as a reception destination to the terminal device upon reception of a name resolution request related to a domain in the second network, transmitted from the terminal device; and access an access destination designated by an access request in the domain corresponding to the virtual address via the proxy device when the access request transmitted to the virtual address is received from the terminal device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a deploy procedure to a cloud environment in an internal network;

FIG. 2 is a block diagram illustrating an example of a configuration of an information processing system according to an embodiment;

FIG. 3 is a block diagram illustrating an example of a hardware configuration of a computer according to an embodiment;

FIG. 4 is a block diagram illustrating an example of a functional configuration of an internal domain name system (DNS) server according to an embodiment;

FIG. 5 is a view illustrating an example of a configuration of data of an address management table;

FIG. 6 is a block diagram illustrating an example of a functional configuration of a proxy access relay device according to an embodiment;

FIG. 7 is a view illustrating an example of a configuration of data of a virtual address management table;

FIG. 8 is a view illustrating an example of an operation of a processing of generating a virtual internet protocol (IP) address;

FIG. 9 is a view illustrating an example of a configuration of data of an authentication management table;

FIG. 10 is a view illustrating an example of a configuration of data of proxy server information;

FIG. 11 is a flowchart illustrating an example of an operation of a terminal;

FIG. 12 is a flowchart illustrating an example of an operation of an internal DNS server;

FIG. 13 is a flowchart illustrating an example of an operation of a relay device;

FIG. 14 is a block diagram illustrating an example of an operation of an information processing system according to an embodiment;

FIG. 15 is a flowchart illustrating an example of an operation of a virtual IP (VIP) management unit;

FIG. 16 is a view illustrating an example of an operation of a relay unit;

FIG. 17 is a flowchart illustrating an example of an operation of an internal DNS server when a relay device is not used; and

FIG. 18 is a view illustrating an example of an operation of an information processing system when a relay device is not used.

### DESCRIPTION OF EMBODIMENTS

In the proxy environment, when an application which is executed in a computer belonging to the internal network does not respond to the proxy access, the application attempts a direct access to the Internet.

However, since the internet access is blocked by a security policy of the internal network, an access to the external network becomes impossible.

Hereinafter, an embodiment of the present disclosure will be described with reference to the drawings. It should be noted that embodiments described below are merely examples and will be embodied with various changes without departing from the spirit of the present disclosure, for example, intention of excluding an application of various modifications or techniques which are not specifically described. Further, in the drawings used for the following embodiments, the same reference numerals denote similar or same parts unless otherwise specifically noted.

### [1] First Embodiment

[1-1] With regard to proxy environment according to comparative example

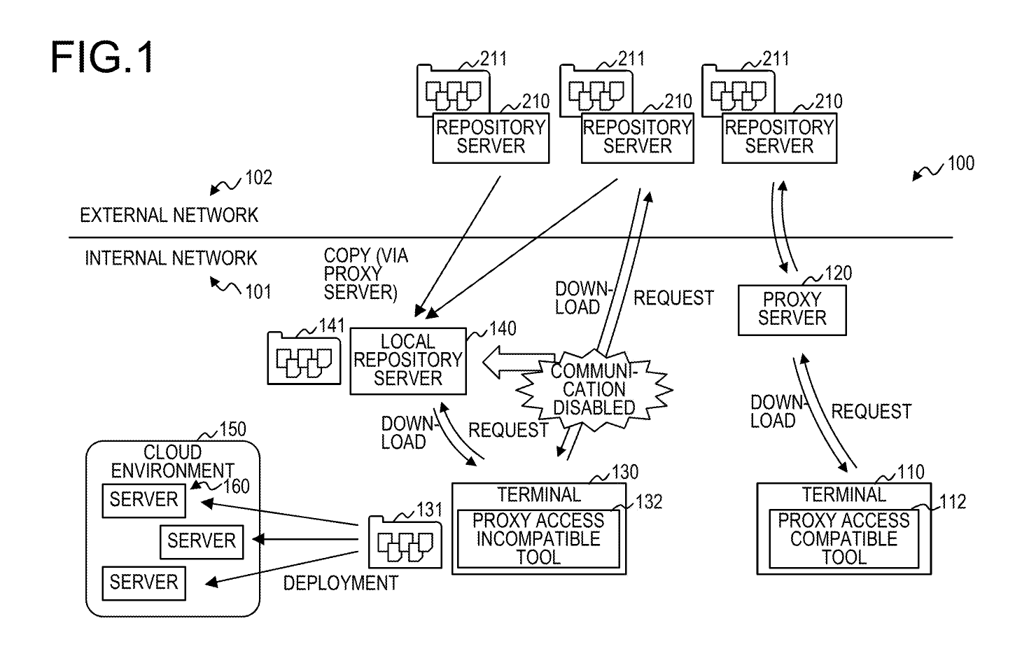

First, an information processing system 100 according to a comparative example of an embodiment will be described with reference to FIG. 1. The information processing system 100 is an example of a proxy environment and, as illustrated in FIG. 1, may include an internal network 101 in which a cloud environment 150 is built and an external network 102 which includes a plurality of repository servers 210.

The cloud environment 150 may be built by an automatic deployment from an infrastructure as a service (IaaS) base to a platform as a service (PaaS) base, an application executing environment, and applications. In this case, a resource 211 used for the deployment is downloaded from the repository server 210 on the external network 102 such as the Internet into the internal network 101 such as an in-company network.

Examples of the resource 211 may include file resources for installing an operating system (OS) such as Linux (registered trademark), IaaS based software, or PaaS based software, and software and applications. Further, the repository server 210 is a server which manages and provides file resources constituting an OS, software, or applications for every version.

When the cloud environment 150 is built in the internal network 101, access to the external network 102 is limited to a proxy access via the proxy server 120 by a security policy of the internal network 101.

For example, a terminal 110 including a tool 112 (referred to as “proxy access compliant tool”) corresponding to the proxy access may access the repository server 210 via the proxy server 120.

In the meantime, for example, when software for deployment performs an external access which does not comply with the proxy access, such as an http access to the repository server 210, the software may not have a function of requesting the external access to the proxy server 120. Hereinafter, “http” is an abbreviation of hypertext transfer protocol.

In this case, even though a terminal 130 having the software 132 (referred to as “proxy access incompliant tool”) attempts a direct access to the external network 102, the access is blocked by the security policy of the internal network 101. As a result, the deployment resource 211 is not downloaded so that the automatic deployment may not be completed.

In order to avoid the above-mentioned situation, for example, an alternative method of installing a local repository server 140 in the internal network 101 may be considered. According to the alternative method, the contents provided by the repository server 210 are copied in advance to the local repository server 140 as a resource 141. Further, whenever the contents provided by the repository server 210 are updated, the resource 141 is updated.

Accordingly, the terminal 130 downloads the resource 141 from the local repository server 140 to obtain a resource 131 and performs a deployment for a plurality of servers 160 in the cloud environment 150 using the resource 131. Here, the terminal 130 may perform the deployment for one of the servers 160.

However, in the above-described alternative method, since the following operations are performed, cost may be increased in terms of cost and management.

A local repository server 140 is newly installed in the internal network 101.

Whenever a resource 211 provided by the repository server 210 is updated, the resource 141 is updated.

A setting for switching an acquisition destination (http access destination) of the resource 141 from the repository server 210 to the local repository server 140 is performed for the terminal 130 including the proxy access incompliant tool 132.

Therefore, in an embodiment, a method for allowing a terminal 130 including a proxy access incompliant tool 132 to access the external network 102 via the proxy server 120 without changing a specific setting will be described.

[1-2] Example of Configuration of Information Processing System According to Embodiment

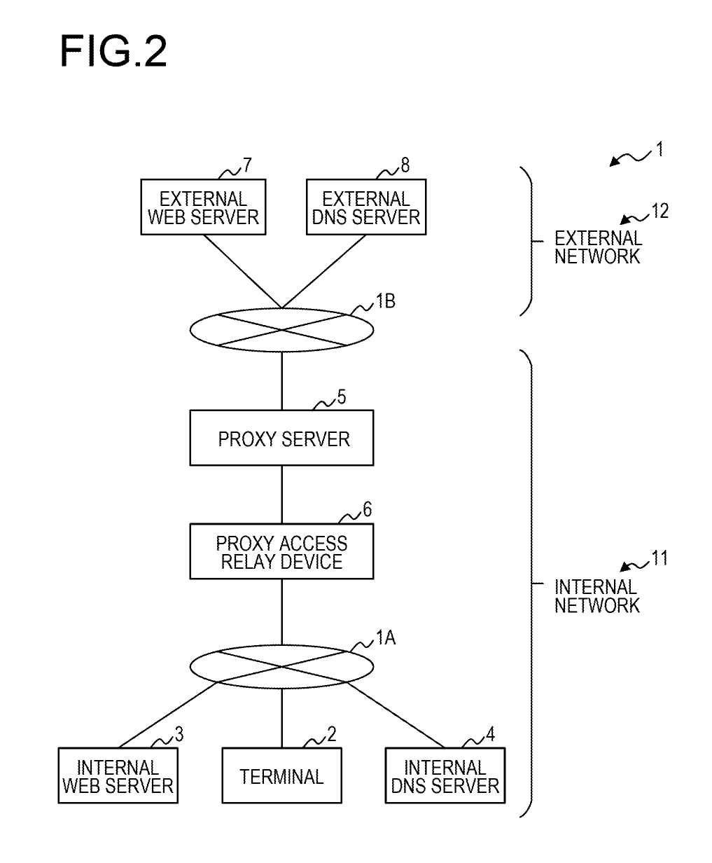

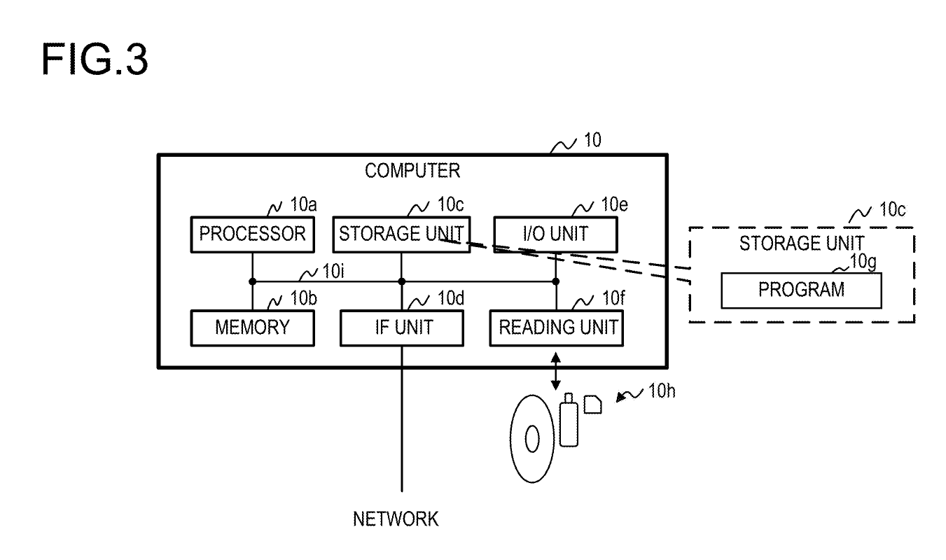

FIG. 2 is a block diagram illustrating an example of a configuration of an information processing system 1 according to an embodiment and FIG. 3 is a block diagram illustrating an example of a hardware configuration of a computer 10.

As illustrated in FIG. 2, the information processing system 1 may illustratively include a terminal 2, an internal web server 3, an internal domain name system (DNS) server 4, a proxy server 5, a proxy access relay device 6, an external web server 7, and an external DNS server 8. In this case, in the example of FIG. 2, even though each of devices denoted by reference numerals 2 to 8 which are provided in the information processing system 1 is one, at least one of the devices denoted by reference numerals 2 to 8 which are provided in the information processing system 1 may be plural.

The terminal 2, the internal web server 3, the internal DNS server 4, and the proxy access relay device 6 may be connected to communicate with each other through a network 1A. Further, the proxy server 5 may be additionally connected to the network 1A. The devices denoted by reference numerals 2 to 6 may be included in the internal network 11 as an example of a first network.

Further, the proxy server 5, the external web server 7, and the external DNS server 8 may be connected to communicate with each other through a network 1B. Further, the external web server 7 and the external DNS server 8 may be included in an external network 12 as an example of a second network.

The network 1A may include a local area network (LAN) or a wide area network (WAN) and may also include a network apparatus such as one or more switches which are not illustrated. Further, the network 1B may include the Internet, LAN, or WAN. The devices denoted by reference numerals 2 to 8 and the network 1A or 1B may be connected through an Ethernet (registered trademark) cable or an optical cable.

The terminal 2 is an example of a terminal device which belongs to the internal network 11 and does not have a proxy access function, and for example, may correspond to the terminal 130 illustrated in FIG. 1.

When the terminal 2 performs an http access to the internal web server 3 or the external web server 7, the terminal 2 may transmit a name resolution request including information of a “name” of an access destination to the internal DNS server 4. When the terminal 2 receives a response result of the name resolution request from the internal DNS server 4, the terminal 2 may perform an http access to “access address information” included in the response result.

The “name” of an access destination may be a domain (or a host). The display format of the domain may be, for example, a fully qualified domain name (FQDN). The FQDN may be a character string including a domain name or a host name. Further, the “access address information” may be information on an address such as, for example, an internet protocol (IP) address.

The internal web server 3 is a server which provides web contents to the internal network 11 and, for example, may correspond to one of the plurality of servers 160 which configures the cloud environment 150 illustrated in FIG. 1.

The internal DNS server 4 is an example of a name resolution device which transmits an address corresponding to the domain in response to a name resolution request related to a domain in the internal network 11. For example, the internal DNS server 4 may associate the FQDN (hereinafter, referred to as “internal FQDN” for the sake of convenience) of each device existing in the internal network 11 with the IP address of the device to manage the FQDN and the IP address.

The proxy server 5 belongs to the internal network 11 and is an example of a proxy device which relays communication between the internal network 11 and the external network 12. For example, the proxy server 5 may perform an access to the external web server 7 in the internal network 12 from the terminal 2 in the internal network 11 on behalf of the terminal 2 which is a request sender.

The proxy access relay device (hereinafter, may be simply referred to as a “relay device”) 6 is an example of an information processing apparatus installed between the terminal 2 and the proxy server 5. For example, the relay device 6 may receive an access request to the external network 12 from the terminal 2 and transmit the access request to the proxy server 5. Details of the relay device 6 will be described below.

The external web server 7 is a server which provides web contents to the external network 12 and, for example, may correspond to one of the plurality of repository servers 210 illustrated in FIG. 1.

The external DNS server 8 performs a name resolution of each device in the external network 12. For example, the external DNS server 8 may associate FQDN (hereinafter, may be referred to as “external FQDN” for the sake of convenience) of each device provided in the external network 12 with the IP address of the device to manage the FQDN and the IP address.

(Example of Hardware Configuration)

An example of a hardware configuration of each device denoted by reference numerals 2 to 8 will be described. Further, these devices may have the same hardware configuration. Hereinafter, the devices denoted by reference numerals 2 to 8 are collectively denoted as a computer 10 for the sake of convenience and an example of the hardware configuration of the computer 10 will be described.

As illustrated in FIG. 3, the computer 10 which is an example of an information processing apparatus or a computer may illustratively include a processor 10a, a memory 10b, a storage unit 10c, an interface (IF) unit 10d,an input/output (I/O) unit 10e, and a reading unit 10f.

The processor 10a is an example of an arithmetic processing device which performs various controls and calculations. The processor 10a may be connected to the blocks 10b to 10f through a bus 10i to communicate with each other. As the processor 10a, an integrated circuit (IC) such as a CPU, a GPU, a MPU, a DSP, an ASIC, or a PLD (e.g., FPGA) may be used. Here, CPU is an abbreviation of central processing unit, GPU is an abbreviation of graphics processing unit, and MPU is an abbreviation of micro processing unit. DSP is an abbreviation of digital signal processor and ASIC is an abbreviation of application specific integrated circuit. PLD is an abbreviation of programmable logic device and FPGA is an abbreviation of field programmable gate array.

The memory 10b is an example of hardware in which various data or programs are stored. Examples of the memory 10b may include a volatile memory, for example, RAM such as a dynamic RAM (DRAM). Here, RAM is an abbreviation of random access memory.

The storage unit 10c is an example of hardware in which various data or programs are stored. For example, the storage unit 10c may be used as a secondary storage device of the computer 10c and may store programs such as OS, firmware, or applications and various data. Examples of the storage unit 10c may include a magnetic disk device such as hard disk drive (HDD), a semiconductor drive device such as a solid state drive (SSD), or various storage devices such as a nonvolatile memory. Examples of the nonvolatile memory may include a flash memory, a SCM (storage class memory), or a read only memory (ROM). The storage unit 10c may store a program which executes all or some of various functions of the computer 10.

The IF unit 10d is an example of a communication interface which controls connection and communication with other device through a network 1A or 1B or a network which is not illustrated in FIG. 2. For example, examples of the IF unit 10d may include an adapter conforming to Ethernet (registered trademark) or optical communication (e.g., fiber channel). Further, the computer 10 may include a communication interface which controls connection and communication with a management terminal of a manager or may download a program 10g from a network which is not illustrated, using the communication interface.

The I/O unit 10e may include at least one of an input device such as a mouse, a keyboard, a touch panel, or a manipulation button and an output device such as a display, a projector, or a printer.

The reading unit 10f is an example of a reader which reads data or programs recorded in a recording medium 10h to output the data or programs to the processor 10a. The reading unit 10f may include a connection terminal or device to which the recording medium 10h is connected or inserted. Examples of the reading unit 10f may include an adapter conforming to a universal serial bus (USB), a drive device which performs access to a recording disc, or a card reader which performs access to a flash memory, such as a SD card. Further, the program 10g may be stored in the recording medium 10h.

Examples of the recording medium 10h may include a non-transitory computer readable recording medium such as a magnetic/optical disc or a flash memory. Examples of the magnetic/optical disc may include a flexible disc, a compact disc (CD), a digital versatile disc (DVD), a blue-ray disc, or holographic versatile disc (HVD). Examples of the flash memory may include a USB memory or a semiconductor memory such as an SD card. Further, examples of the CD may include a CD-ROM, a CD-R, or a CD-RW. Further, examples of the DVD may include DVD-ROM, DVD-RAM, DVD-R, DVD-RW, DVD+R, and DVD+RW.

The above-described hardware configuration of the computer 10 is an example. Therefore, in the computer 10, the hardware may be appropriately increased/reduced (for example, an arbitrary block is added or removed), divided, or combined by an arbitrary combination, or a bus may be arbitrarily added or omitted.

(Example of Functional Configuration)

Next, an example of a functional configuration of an internal DNS server 4 and a proxy access relay device 6 will be described.

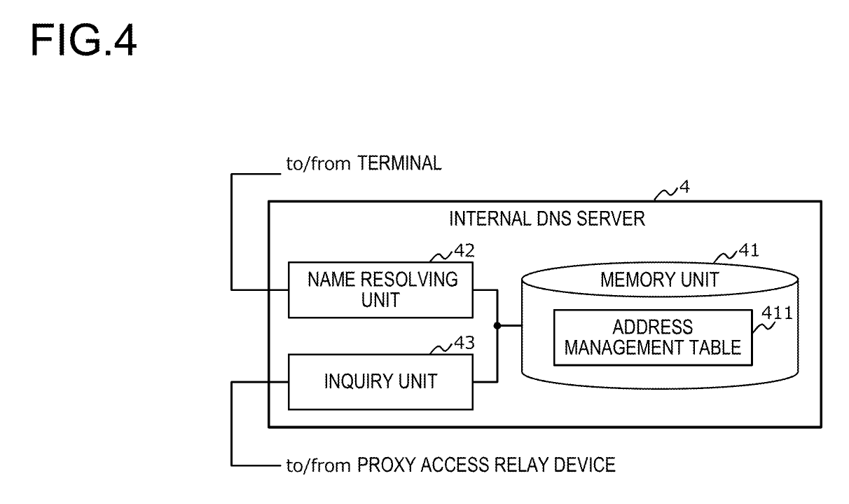

First, an example of a functional configuration of the internal DNS server 4 will be described. As illustrated in FIG. 4, the internal DNS server 4 may illustratively include a memory 41, a name resolving unit 42, and an inquiry unit 43.

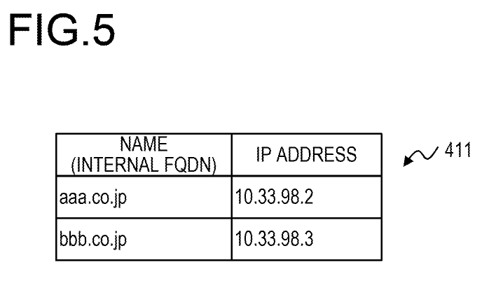

The memory unit 41 may store information of an address management table 411. FIG. 5 illustrates an example of a data configuration of the address management table 411. As illustrated in FIG. 5, the address management table 411 may illustratively include a “name” such as, for example, “internal FQDN” and “IP address”. Further, the memory unit 41 may be implemented by at least a part of a storage area of the memory unit 10b or the storage unit 10c (see, e.g., FIG. 3) of the internal DNS server 4.

When the name resolution request is received from the terminal 2, the name resolving unit 42 resolves the name based on the address management table 411 and responds the result to the terminal 2 for a case when the name is resolved. For example, when the name resolving unit 42 receives a request for resolving a name related to internal FQDN “aaa.co.jp” from the terminal 2, the name resolving unit 42 may refer to the address management table 411. The name resolving unit 42 may transmit the IP address “10.33.98.2” associated with the internal FQDN “aaa.co.jp” (see, e.g., FIG. 5) to the terminal 2 as a response.

When the name resolving unit 42 cannot resolve the name, for example, when a FQDN included in the name resolution request does not exist in the address management table 411, the inquiry unit 43 transmits the name resolution request to the relay device 6. Here, for example, when the FQDN is an external FQDN, the FQDN included in the name resolution request may not exist in the address management table 411.

When the internal DNS server 4 has a function of requesting name resolution to other device (e.g., other DNS server) if the name resolution fails, the function may be used as the inquiry unit 43. In this case, information on the relay device 6, for example, an IP address may be designated as a request destination of the function.

Next, an example of a functional configuration of the relay device 6 will be described. The relay device 6 receives an http access to the external FQDN from software on the terminal 2 and performs a process to convert the http access to the external FQDN into an access via a proxy server 5.

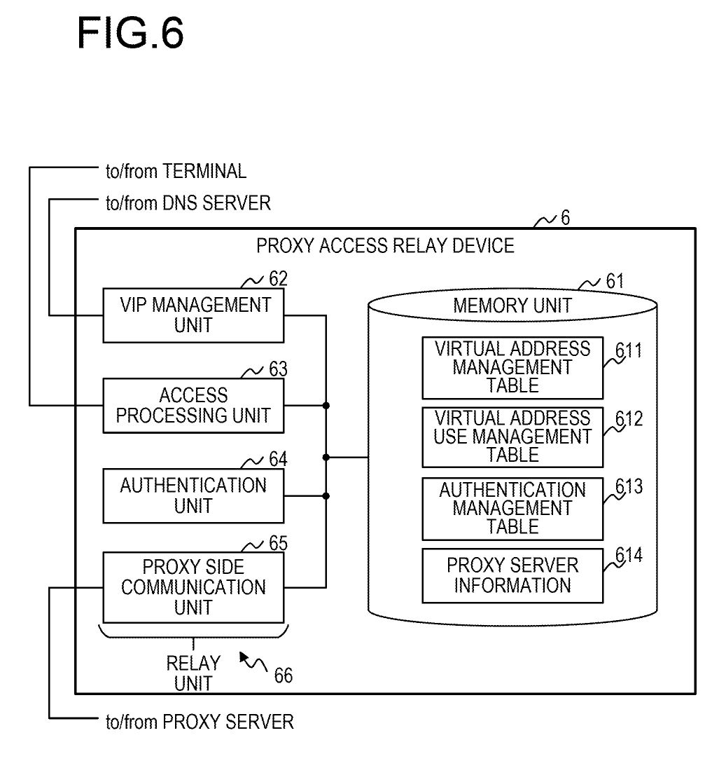

As illustrated in FIG. 6, the relay device 6 may illustratively include a memory unit 61, a virtual IP (VIP) management unit 62, an access processing unit 63, an authentication unit 64, and a proxy side communication unit 65. Hereinafter, the management unit 62, the access processing unit 63, the authentication unit 64, and the proxy side communication unit 65 may be collectively denoted as a relay unit 66.

The memory unit 61 may store a virtual address management table 611, virtual address use management table 612, an authentication management table 613, and proxy server information 614. Details of the tables 611 to 614 will be described hereinbelow in the description of the relay unit 66. Further, the memory unit 61 may be implemented by at least a part of a storage area of the memory unit 10b or the storage unit 10c (see, e.g., FIG. 3) of the relay device 6.

The VIP management unit 62 is an example of a virtual address management unit which transmits the virtual address having the relay device 6 as a receiving destination to the terminal 2, as a response, upon reception of a name resolution request related to a domain in the external network 12 and transmitted from the terminal 2.

For example, the VIP management unit 62 may have a DNS server function which replies the corresponding IP address for the name resolution request of the FQDN. The VIP management unit 62 may reply the virtual IP address of the relay device 6 for the name resolution request of the external FQDN transmitted from the internal DNS server 4, using the DNS server function. Therefore, the VIP management unit 62 may register and manage corresponding information of the external FQDN and the IP address.

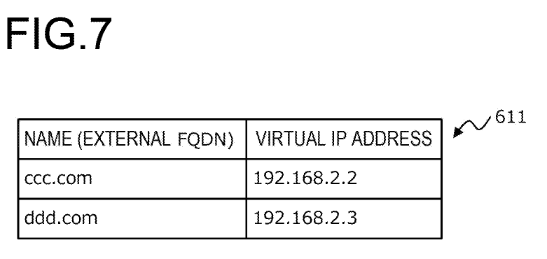

FIG. 7 illustrates an example of a data configuration of the virtual address management table 611. The virtual address management table 611 is an example of virtual address management information obtained by associating in which non-repetitive virtual addresses having the relay device 6 as a reception destination with every domain in the external network 12. As illustrated in FIG. 7, the virtual address management table 611 may illustratively include a “name” such as, for example, an “external FQDN” and an “IP address”.

For example, when the external FQDN included in the name resolution request does not exist in the virtual address management table 611, the VIP management unit 62 newly generates a virtual IP address and uses the generated virtual IP address as an IP address of a web server (will be described below) in the relay device 6. Further, the VIP management unit 62 associates the virtual IP address with the external FQDN included in the name resolution request one to one to be registered in the virtual address management table 611 and transmits the virtual IP address to the internal DNS server 4 as a response to the name resolution request.

When the external FQDN included in the name resolution request exists in the virtual address management table 611, the VIP management unit 62 reads the virtual IP address corresponding to the FQDN from the virtual address management table 611 to respond to the internal DNS server 4.

When the internal DNS server 4 or the relay device 6 replies an original IP address corresponding to the external FQDN to the name resolution request of the external FQDN from the software of the terminal 2, the following problems may be incurred. That is, as described above, the http access software on the terminal 2 is blocked due to a security policy of the internal network 11 such as, for example, a policy which blocks an internet access which is not via the proxy server 5.

Even though the internal DNS server 4 or the relay device 6 replies the IP address of the proxy server 5, the processing of the proxy server 5 is different from that of a web (http) server and a port number of a transmission control protocol (TCP) which waits for communication is also different. For example, in many cases, the http server adopts a port No. 80 and the proxy server 5 employs a port No. 8080. Therefore, the http access may not be allowed without changing the software on the terminal 2.

Therefore, the VIP management unit 62 replies a virtual IP address in the relay device 6 which is an alternative, rather than the original IP address (e.g., IP address of the external web server 7) or the IP address of the proxy server 5, to allow the relay device 6 to perform an http access from the terminal 2.

As described above, the virtual IP address and the external FQDN are associated one to one to be managed. Therefore, in order to deal with a case where a plurality of external FQDNs of a http access destination exist, the VIP management unit 62 generates a plurality of virtual IP addresses to manage the FQDNs and the virtual IP addresses. Further, instead of the plurality of virtual IP addresses, an address obtained by combining one virtual IP address (or a plurality of IP addresses) and one of a plurality of port numbers which may be received by the relay device 6 may be used. In this case, a virtual IP address plus port number and a plurality of external FQDNs may be associated one to one, by different port numbers. In the following description, the address represented by the virtual IP address plus port number is also simply referred to as “virtual IP address”.

The VIP management unit 62 may manage a candidate of the virtual IP address of the relay device 6 which is allocated to the external FQDN using the virtual address use management table 612.

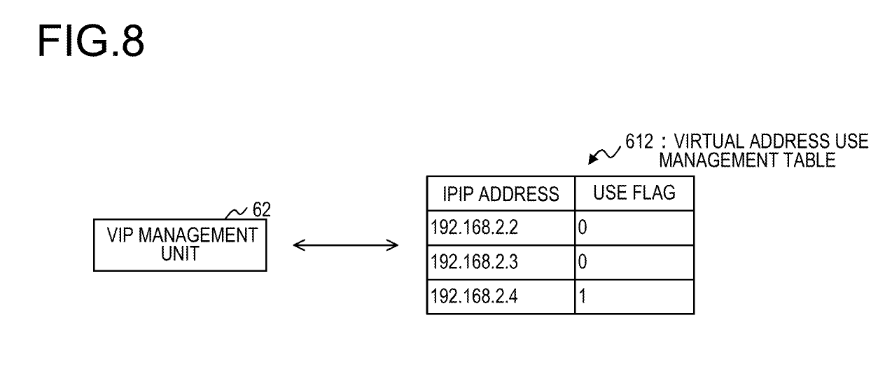

FIG. 8 is a view illustrating an example of an operation of a processing of generating a virtual IP address. As illustrated in FIG. 8, the virtual address use management table 612 may illustratively include an “IP address” and a “use flag” which are registered in advance.

With respect to the virtual address use management table 612, the VIP management unit 62 registers an IP address which is not repetitive with other computer 10 in a sub network address in which the relay device 6 is installed and manages a usage situation of the IP address as a use flag. For example, when the IP address is used (exists in the virtual address management table 611), “1” is set in the “use flag”. When the IP address is not used (does not exist in the virtual address management table 611), “0” is set in the use flag.

For example, when the external FQDN included in the name resolution request is not included in the virtual address management table 611, the VIP management unit 62 may withdraw an IP address indicating that the use flag is not used, as a virtual IP address, from the virtual address use management table 612.

The relay unit 66 is an example of a relay processing unit which when an access request transmitted to the virtual address is received from the terminal 2, accesses an access destination designated in the access request in a domain corresponding to the virtual address via the proxy server 5. Hereinafter, the access processing unit 63, the authentication unit 64, and a proxy side communication unit 65 of the relay unit 66 will be described.

The access processing unit 63 may have a web server function. The web server function may include a function of receiving an http access request to the virtual IP address set to the access processing unit 63 by the VIP management unit 62, from the terminal 2 and transmitting a response of the http access to the terminal 2. Further, the response of the http access may be obtained through the authentication unit 64 and the proxy side communication unit 65 which will be described below.

The authentication unit 64 is an example of an access authentication unit which authenticates an access request based on the address of the terminal 2 which is an access source of the access request. The access authentication is a security mechanism which receives the processing from a specific access source and rejects the processing from an access source which is not a target.

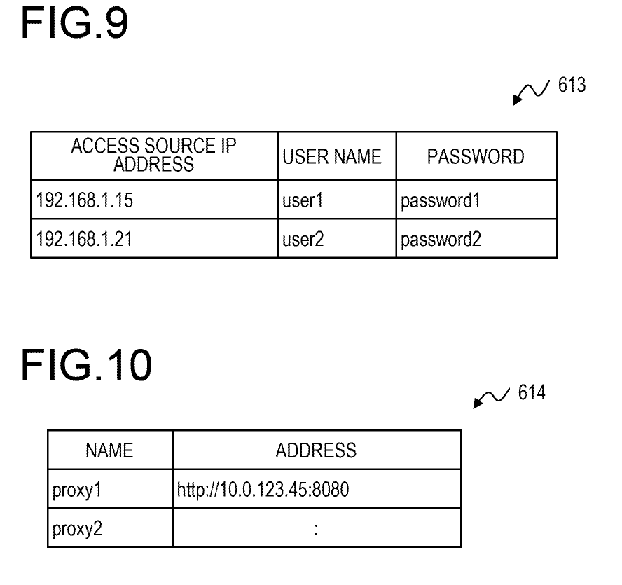

FIG. 9 illustrates an example of a data configuration of an authentication management table 613. As illustrated in FIG. 9, the authentication management table 613 may illustratively include an “access source IP address”, a “user name”, and a “password”. An IP address of the terminal 2 which permits the access may be set as the “access source IP address”. The “user ID” (identifier) and the “password” may be used to authenticate a user by proxy server information 614 which will be described below. Further, the information may be registered in the authentication management table 613 in advance by the user or the manager.

When the IP address of the access source related to the http access exists in the authentication management table 613, the authentication unit 64 determines that “authentication succeeds” and when the IP address of the access source does not exist in the authentication management table 613, the authentication unit 64 determines that “authentication fails”.

The proxy side communication unit 65 may relay the access to the proxy server 5 from the terminal 2, in other words, may perform the access to the proxy server 5 on behalf of the terminal 2. For example, the proxy side communication unit 65 converts the virtual IP address which is an access destination of the http access request into an original external FQDN and requests the http access to the proxy server 5 to receive the http access response and transmit the response to the access processing unit 63.

The proxy side communication unit 65 obtains the original external FQDN of the http access request from the virtual address management table 611 based on the virtual IP address to which the access request is directed in order to obtain the external FQDN corresponding to the virtual IP address.

The proxy side communication unit 65 may obtain information of the proxy server 5 which requests the http access by referring to the proxy server information 614 which is registered in advance by the user or the manager.

FIG. 10 illustrates an example of a data configuration of the proxy server information 614. As illustrated in FIG. 10, the proxy server information 614 may illustratively include a “name” and an “address”. The “name” is an example of identification information of the proxy server 5. The “address” may include the IP address and the port number of the proxy server 5.

However, the proxy server 5 may have a user authentication function in some cases. When the user authentication is requested by the proxy server 5, the proxy side communication unit 65 obtains the user name and the password from the authentication management table 613 based on the access source IP address to transmit the information to the proxy server 5 as a response to the user authentication request.

As described above, the proxy side communication unit 65 is an example of a user authentication unit which transmits the user authentication information corresponding to the terminal 2 which is an access source of the access request to the proxy server 5, as a response, based on the user identification information when the user authentication request is received from the proxy server 5. Further, the user authentication information is an authentication management table 613 and the proxy side communication unit 65 may manage the user authentication information for the proxy server 5 for every terminal 2.

One or both of the access authentication by the above-described authentication unit 64 and the user authentication by the proxy side communication unit 65 may be omitted. For example, it may be permitted that the relay device 6 does not include the authentication unit 64.

[1-3] Example of Operation

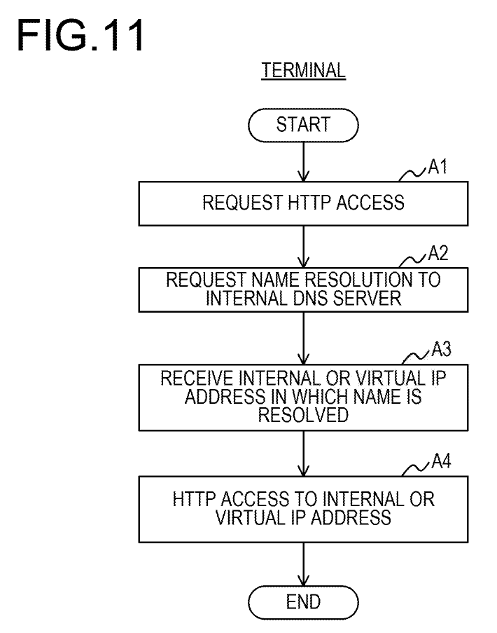

Next, an example of an operation of the information processing system 1 configured as described above will be described with reference to FIGS. 11 to 18.

[1-3-1] Example of Operation of Terminal

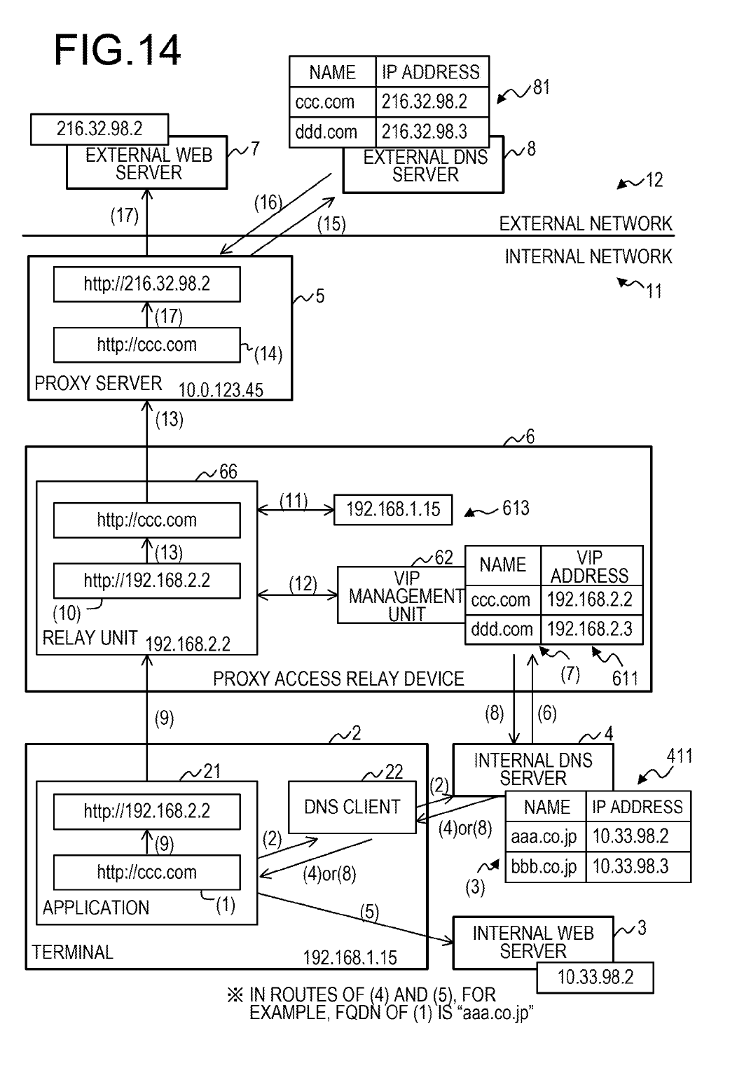

First, an example of an operation of the terminal 2 will be described with reference to FIGS. 11 and 14.

As illustrated in FIG. 11, an http access request to the internal web server 3 or the external web server 7 is generated in the terminal 2 (step A1, see reference numeral (1) of FIG. 14).

The terminal 2 transmits the name resolution request of the FQDN according to the http access request to the internal DNS server 4 (step A2, see an arrow (2) of FIG. 14).

Subsequently, the terminal 2 receives an IP address in which the name is resolved by the internal DNS server 4 such as, for example, the internal IP address or the virtual IP address from the internal DNS server 4 (step A3, see an arrow (4) or (8) of FIG. 14).

The terminal 2 performs the http access to the received IP address (step A4, see an arrow (5) or (9) of FIG. 14) and the processing in the terminal 2 ends.

In an example of FIG. 14, patterns of the arrows (4) and (5) correspond to a case when the FQDN of the reference numeral (1) according to the http access request is an internal FQDN such as, for example, “aaa.co.jp”. Further, patterns of the arrows (8) and (9) correspond to a case when the FQDN of the reference numeral (1) according to the http access request is an external FQDN such as, for example, “ccc.com”.

[1-3-2] Example of Operation of Internal DNS Server

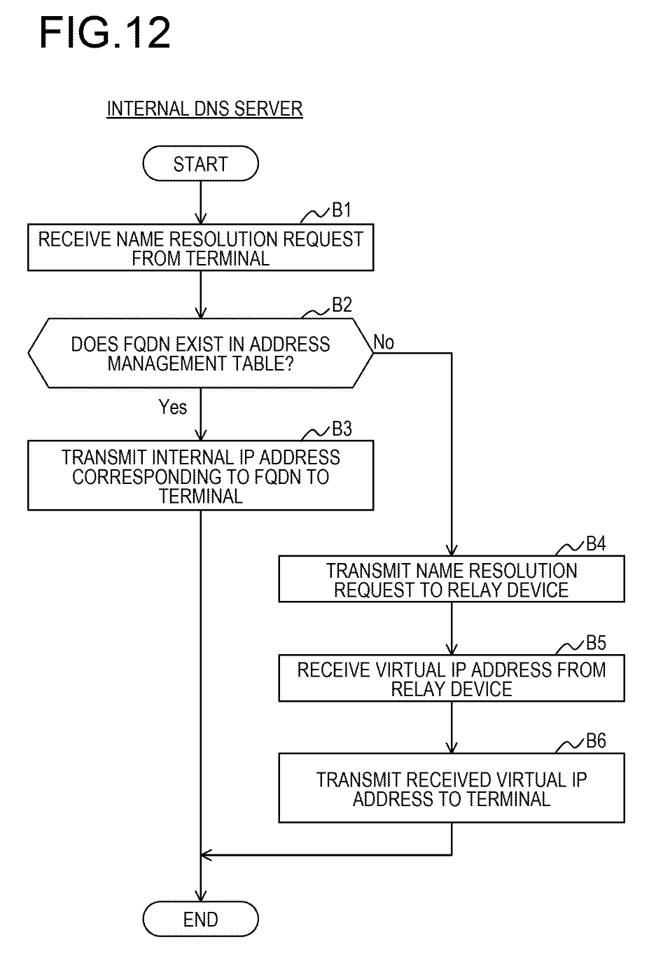

Next, an example of an operation of the internal DNS server 4 will be described with reference to FIGS. 12 and 14.

As illustrated in FIG. 12, when the name resolving unit 42 of the internal DNS server 4 receives a name resolution request from the terminal 2 (step B1), the name resolving unit 42 determines whether the requested FQDN exists in the address management table 411 (step B2, see reference numeral (3) of FIG. 14).

When it is determined that the FQDN exists in the address management table 411 (“Yes” in step B2), the name resolving unit 42 obtains the internal IP address corresponding to the FQDN from the address management table 411 to respond to the terminal 2 (step B3, see an arrow (4) of FIG. 14). And, the processing ends.

In contrast, when it is determined that the FQDN does not exist in the address management table 411 (“No” in step B2), the inquiry unit 43 of the internal DNS server 4 transmits the name resolution request to the relay device 6 (step B4, see an arrow (6) of FIG. 14).

Next, the inquiry unit 43 receives a virtual IP address from the relay device 6 (step B5, see reference numeral (7) of FIG. 14), transmits the received virtual IP address to the terminal 2 as a response (step B6, see an arrow (8) of FIG. 14), and the processing ends.

[1-3-3] Example of Operation of Relay Device

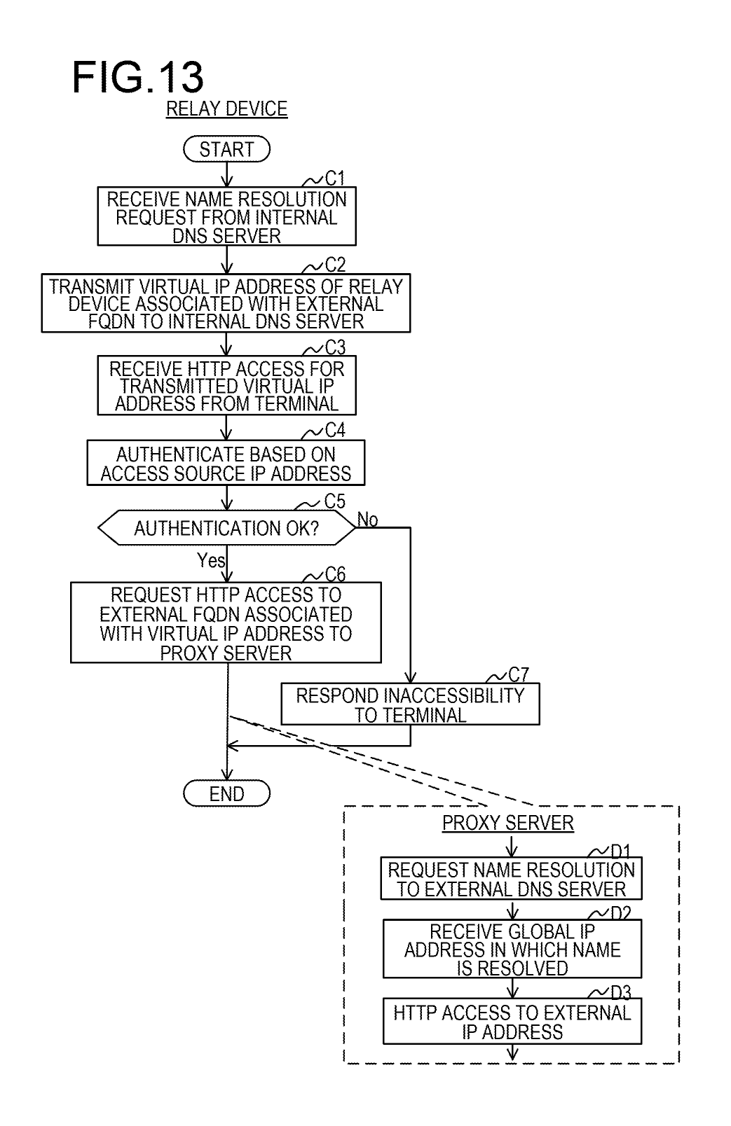

Next, an example of an operation of the relay device 6 will be described with reference to FIGS. 13 and 14.

As illustrated in FIG. 13, the VIP management unit 62 of the relay device 6 receives a name resolution request from the internal DNS server 4 (step C1, see an arrow (6) of FIG. 14). In this case, the FQDN according to the name resolution request is an external FQDN.

The VIP management unit 62 transmits the virtual IP address of the relay device 6 which is associated with the external FQDN to the internal DNS server 4, as a response, based on the virtual address management table 611 (step C2, see reference numeral (7) and an arrow (8) of FIG. 14).

The relay unit 66 of the relay device 6 receives the http access request for the virtual IP address transmitted by the VIP management unit 62, from the terminal 2 (step C3, see reference numeral (10) of FIG. 14).

The relay unit 66 performs an authentication for the http access request based on the access source IP address by referring to the authentication management table 613 (step C4, see an arrow (11) of FIG. 14).

When the authentication succeeds (step C5, “Yes” in step C5), the relay unit 66 requests the http access for the external FQDN associated with the virtual IP address to the proxy server 5 (step C6, see arrows (12) and (13) of FIG. 14) and the processing ends.

In contrast, when the authentication fails (“No” in step C5), the relay unit 66 responds inaccessibility to the terminal 2 (step C7), and the processing ends.

In step C6, the proxy server 5 which receives a request for the http access to the external FQDN may operate as follows.

For example, as illustrated in FIG. 13, the proxy server 5 requests the name resolution to the external DNS server 8 (step D1, see an arrow (15) of FIG. 14) with respect to the external FQDN (see reference numeral (14) of FIG. 14) related to the http access.

Next, the proxy server 5 receives a global IP address in which the name is resolved from the external DNS server 8 (step D2, see an arrow (16) of FIG. 14). Further, the name resolution by the external DNS server 8 may be performed based on the address management table 81 as illustrated in FIG. 14.

The proxy server 5 performs an http access requested from the relay device 6 to the external web server 7 having the received global IP address (step D3, see an arrow (17) of FIG. 14), and the processing ends.

[1-3-4] Example of Operation of VIP Management Unit and Relay Unit

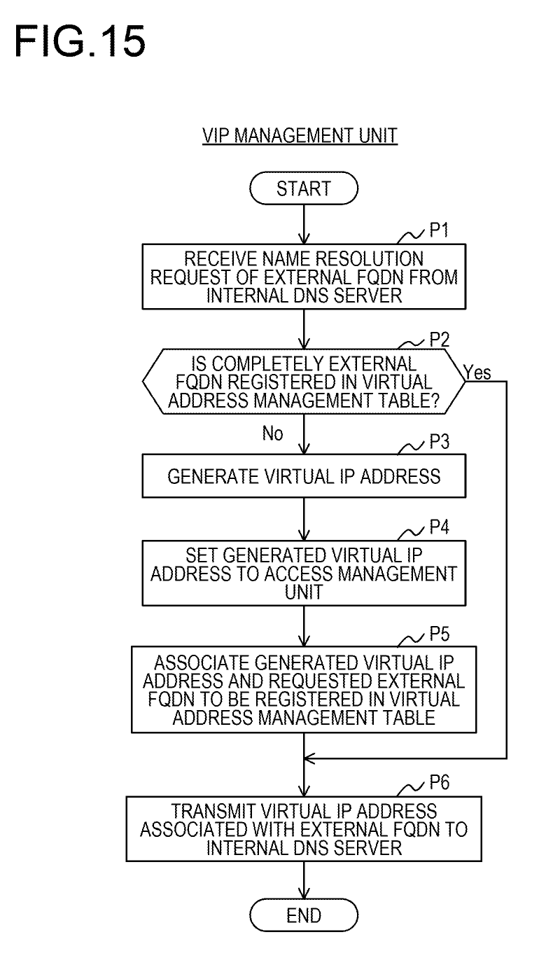

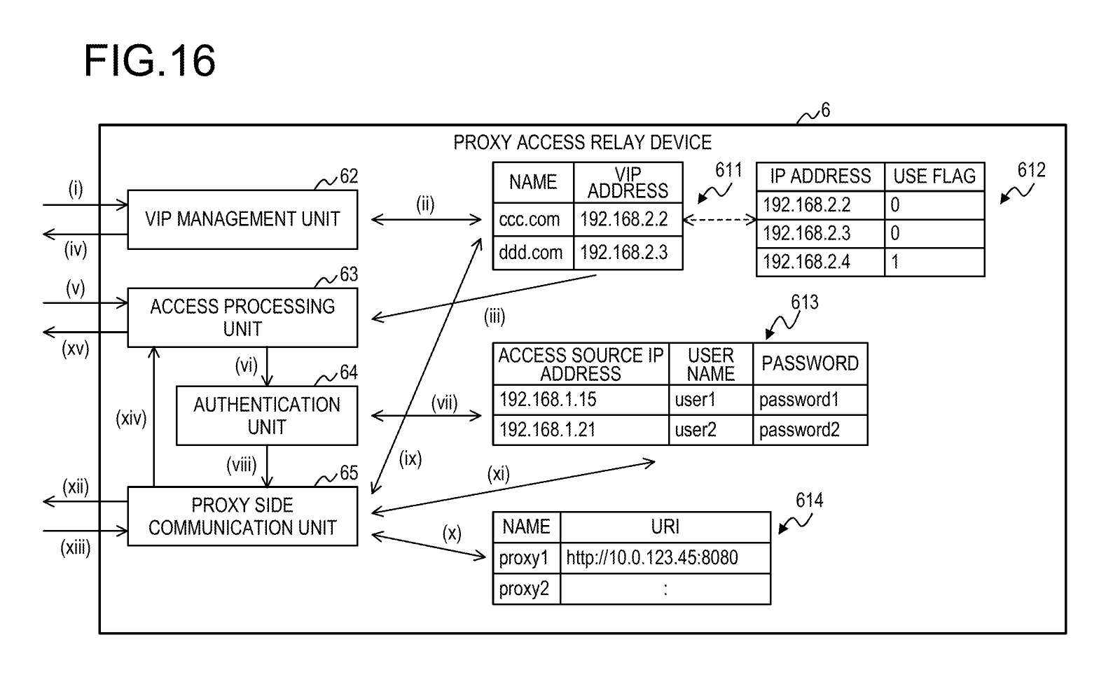

Next, an example of a detailed operation of the relay device 6, for example, examples of operations of the VIP management unit 62 and the relay unit 66 will be described with reference to FIGS. 15 and 16.

As illustrated in FIG. 15, the VIP management unit 62 of the relay device 6 receives a name resolution request of the external FQDN from the internal DNS server 4 (step P1, see an arrow (6) of FIG. 14 and an arrow (i) of FIG. 16). The VIP management unit 62 determines whether the external FQDN is completely registered in the virtual address management table 611 (step P2, see an arrow (ii) of FIG. 16). When it is determined that the registration is completed (“Yes” in step P2), the processing moves to step P6.

In the meantime, when it is determined that the external FQDN is not registered in the virtual address management table 611 (“No” in step P2), the VIP management unit 62 generates a virtual IP address based on the virtual address use management table 612 (step P3). The virtual IP address may be generated using an IP address which is not used in the virtual address use management table 612 (see, e.g., FIG. 16).

The VIP management unit 62 sets the generated virtual IP address in the access processing unit 63 (step P4, see an arrow (iii) of FIG. 16). Further, the VIP management unit 62 associates the generated virtual IP address with the requested external FQDN to be registered in the virtual address management table 611 (step P5, see reference numeral (7) of FIG. 14).

The VIP management unit 62 transmits the virtual IP address corresponding to the external FQDN to the internal DNS server 4 as a response (step P6, see an arrow (8) of FIG. 14 and an arrow (iv) of FIG. 16), and the processing of the VIP management 62 ends.

As illustrated in FIG. 16, when the access processing unit 63 of the relay unit 66 receives an http access request from the terminal 2 for the set virtual IP address (see an arrow (v), the access processing unit notifies the IP address of the access source of the authentication unit 64 (see an arrow (vi)).

The authentication unit 64 determines whether the IP address of the access source exists in the authentication management table 613 to perform access authentication (see an arrow (vii)). When the authentication succeeds, the http access request is notified to the proxy side communication unit 65 (see an arrow (viii)).

The proxy side communication unit 65 obtains the external FQDN corresponding to the virtual IP address from the virtual address management table 611 (see an arrow (ix)).

The proxy side communication unit 65 obtains an URI of the proxy server 5 which transmits the http access request such as, for example, URL and information of the port number, by referring to the proxy server information 614 (see an arrow (x)).

The proxy side communication unit 65 transmits the http access request to the proxy server 5 (see an arrow (xii) and receives a response for the request from the proxy server 5 (see an arrow (xiii). When the proxy server 5 requests the user authentication, the proxy side communication unit 65 may obtain the user name and the password from the authentication management table 613 based on the IP address of the terminal 2 (see an arrow (xi) and transmit the user name and the password to the proxy server 5 as a response to the user authentication request.

The response to the access request from the proxy server 5 is transmitted from the proxy side communication unit 65 to the access processing unit 63 (see an arrow (xiv)) and transmitted from the access processing unit 63 to the terminal 2 (see an arrow (xv)).

As described above, according to an embodiment, the relay device 6 which performs the proxy access on behalf of the terminal 2 is provided between software which performs the http access on a client computer such as the terminal 2 and the proxy server 5. Therefore, the software may access the external network 12 via the proxy server 5 without modifying the software of the terminal 2 or the proxy server 5 or without changing a setting, in other words, without being aware of the proxy server 5.

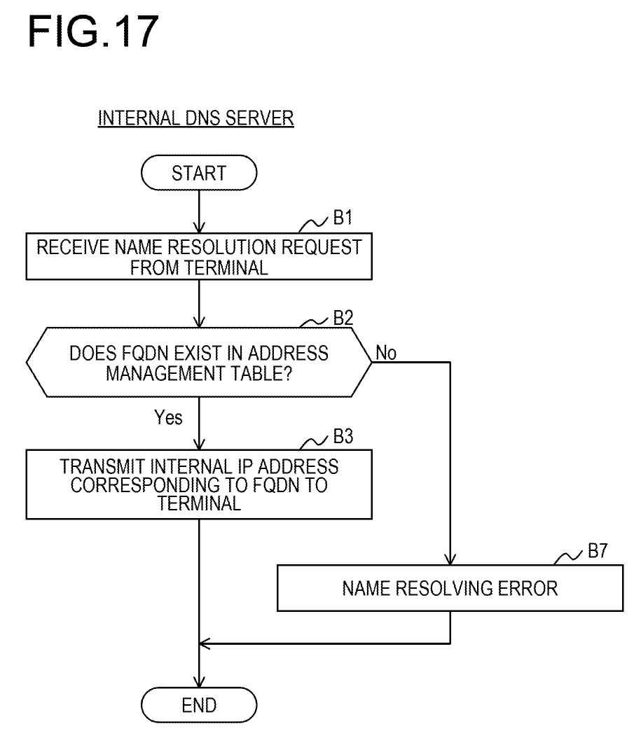

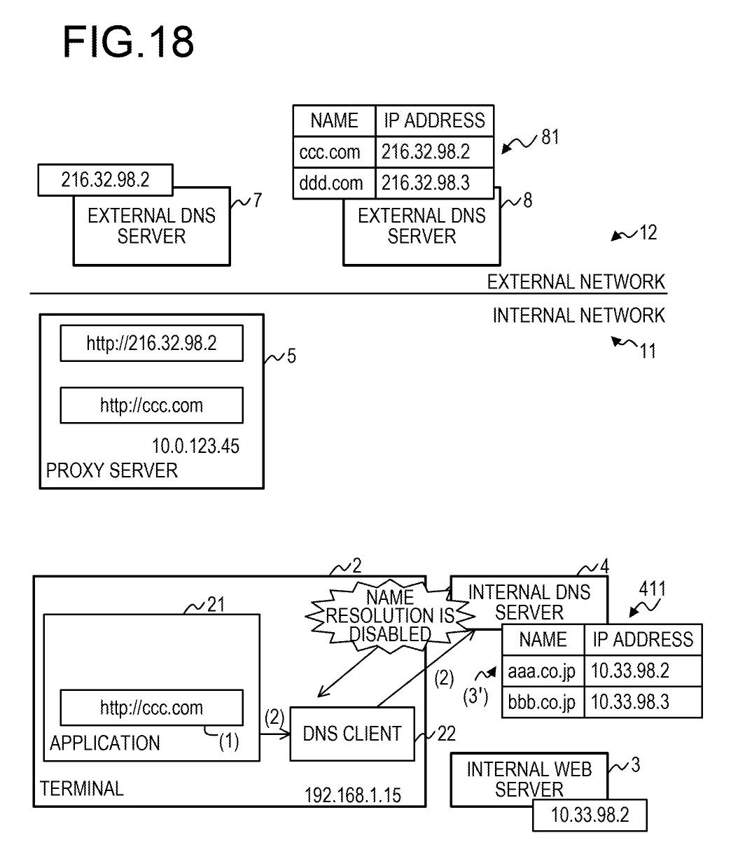

FIGS. 17 and 18 are views of an example of an operation when the relay device 6 is not used. When there is an http access to the external FQDN from the terminal 2, the internal DNS server 4 may not resolve the name of the external FQDN (see reference numeral (3′) of FIG. 18). Therefore, a name resolving error is incurred (“No” in step B2 and step B7 of FIG. 17, see FIG. 18), so that the access from the terminal 2 fails.

As described above, when the internal DNS server 4 cannot resolve the name by itself, as described above, the internal DNS server 4 has a function of inquiring to other DNS server. However, even though the internal DNS server inquiries the external DNS server 8 to resolve the name, the access to the outside network is blocked by the security policy. Therefore, the terminal 2 may not directly perform the http access to the server on the Internet without going through the proxy server 5.

In contrast, based on information determining whether the name of the FQDN of the access destination is resolved by the internal DNS server, the VIP management unit 62 of the relay device 6 determines that it is an internet access to the outside when the name resolution is disabled. Further, the VIP management unit 62 automatically generates a virtual IP address corresponding to the FQDN of the external web server 7 to manage a correspondence relationship and replies the generated virtual IP address to the terminal 2 so that an access to the relay device 6 (virtual IP address) from the terminal 2 is allowed.

The relay unit 66 of the relay device 6 converts the virtual IP address of the access destination from the terminal 2 into an original FQDN and relays the external access from the terminal 2 via the proxy server 5. Therefore, even though the terminal 2 does not correspond to the proxy access, an access via the proxy server 5 may be implemented. Therefore, for example, in the cloud environment as illustrated in FIG. 1, the resource may be downloaded from the repository server on the Internet by the deploy software which does not correspond to the proxy access.

### [2] Others

Technologies according to the above-described embodiment may be modified or changed to be embodied as follows.

A functional block which is provided in the relay device 6 may be combined by various combinations or divided.

The function of the relay device may be implemented by a multiprocessor or multicore processor 10a.

The relay device 6 according to an embodiment may be used by a terminal 2 having software corresponding to the proxy access. For example, in the terminal 2, a setting for proxy access is not necessary for the software so that convenience may be improved and a risk of a setting an error may be reduced.

A setting for proxy access may include settings of an IP address or a port number of the proxy server 5, a user name, a password, or a proxy exception list. These settings may be different in terms of methods according to the software.

The function of the relay device 6 may be integrated or distributed to one or both of the internal DNS server 4 and the proxy server 5.

For example, the function of the relay device 6 and the function of the internal DNS server 4 may be integrated (combined). In this case, when the name resolution fails by the function of the name resolving unit 42 of the internal DNS server 4, the function of the VIP management unit 62 may operate.

The function of the relay device 6 and the function of the proxy server 5 may be integrated (combined) and in this case, the setting of the proxy access may be omitted in the terminal 2 in the internal network 11 regardless of the correspondence/non-correspondence of the proxy access. That is, the user or the manager may not be conscious of the presence of the proxy server 5 in the internal network 11 having a function of the proxy server 5 so that a management cost in the internal network 11 may be saved substantially.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. An information processing apparatus provided between a terminal device which belongs to a first network and a proxy device which belongs to the first network and relays communication between the first network and a second network, the information processing apparatus comprising:
a memory; and
a processor coupled to the memory and the processor configured to:
transmit a virtual address having the information processing apparatus as a reception destination to the terminal device, as a response, upon receiving of a name resolution request related to a domain in the second network and transmitted from the terminal device; and
access an access destination designated by an access request in the domain corresponding to the virtual address via the proxy device when the access request transmitted to the virtual address is received from the terminal device.

2. The information processing apparatus according to claim 1, wherein the processor manages virtual address management information obtained by associating non-repetitive virtual addresses having the information processing apparatus as a reception destination with every domain in the second network.

3. The information processing apparatus according to claim 2, wherein when a domain related to the name resolution request does not exist in the virtual address management information, the processor corresponds an unused virtual address to the domain to be registered in the virtual address management information and sets the virtual address in the information processing apparatus.

4. The information processing apparatus according to claim 1, wherein when a response for the access request is received from the proxy device, the processor transmits the response to the terminal device.

5. The information processing apparatus according to claim 1, wherein in a name resolving device which transmits an address corresponding to the domain for the name resolution request related to a domain in the first network, when the name resolution for the name resolution request from the terminal device fails, the name resolution request is a request which is transmitted from the name resolving device to the information processing apparatus.

6. The information processing apparatus according to claim 1, wherein the processor is further configured to:
authenticate the access request based on an address of a terminal which is an access source of the access request.

7. The information processing apparatus according to claim 1, wherein the processor is further configured to:
manage user authentication information for the proxy device for every terminal device and when the user authentication request is received from the proxy device, transmit user authentication information corresponding to a terminal device which is an access source of the access request to the proxy device, as a response, based on the user authentication information.

8. An information processing system, comprising:
a terminal device which belongs to a first network;
a proxy device which belongs to the first network and relays communication between the first network and a second network; and
an information processing apparatus provided between the terminal device and the proxy device,
wherein the information processing apparatus includes:
a memory; and
a processor coupled to the memory and the processor configured to:
transmit a virtual address having the information processing apparatus as a reception destination to the terminal device upon receiving of a name resolution request related to a domain in the second network, and transmitted from the terminal device; and
access an access destination designated by an access request in the domain corresponding to the virtual address via the proxy device when the access request transmitted to the virtual address is received from the terminal device.

9. The information processing system according to claim 8, wherein the processor manages virtual address management information obtained by associating non-repetitive virtual addresses having the information processing apparatus as a reception destination with every domain in the second network.

10. The information processing system according to claim 9, wherein when a domain related to the name resolution request does not exist in the virtual address management information, the processor corresponds an unused virtual address to the domain to be registered in the virtual address management information and sets the virtual address in the information processing apparatus.

11. The information processing system according to claim 8, wherein when a response for the access request is received from the proxy device, the processor transmits the response to the terminal device.

12. The information processing system according to claim 8, wherein the processor is further configured to:
transmit an address corresponding to the domain for a name resolution request related to a domain in the first network,
wherein when the name resolution for the name resolution request from the terminal device fails, the processor transmits the name resolution request to the information processing apparatus.

13. The information processing system according to claim 8, wherein the processor of the information processing apparatus is further configured to authenticate the access request based on an address of a terminal which is an access source of the access request.

14. The information processing system according to claim 8, wherein the proxy device authenticates a user for the received access request and
the processor of the information processing apparatus is further configured to manage user authentication information for the proxy device for every terminal device and transmit user authentication information corresponding to a terminal device which is an access source of the access request to the proxy device, based on the user authentication information when the user authentication request is received from the proxy device.

15. A non-transitory computer-readable recording medium having stored therein an information processing program for causing an information processing apparatus provided between a terminal device which belongs to a first network and a proxy device which belongs to the first network and relays communication between the first network and a second network, to execute a process, the process comprising:
transmitting a virtual address having the information processing apparatus as a reception destination to the terminal device, as a response, upon receiving of a name resolution request related to a domain in the second network and transmitted from the terminal device; and
accessing an access destination designated by an access request in the domain corresponding to the virtual address via the proxy device when the access request transmitted to the virtual address is received from the terminal device.

16. The non-transitory computer-readable recording medium according to claim 15, the process further comprising:
managing virtual address management information obtained by associating non-repetitive virtual addresses having the information processing apparatus as a reception destination with every domain in the second network.

17. The non-transitory computer-readable recording medium according to claim 16, the process further comprising:
corresponding an unused virtual address to the domain to be registered in the virtual address management information and setting the virtual address in the information processing apparatus when a domain related to the name resolution request does not exist in the virtual address management information.

18. The non-transitory computer-readable recording medium according to claim 15, the process further comprising:
transmitting the response to the terminal device when the response for the access request is received from the proxy device.

19. The non-transitory computer-readable recording medium according to claim 15, wherein in a name resolving device which transmits an address corresponding to the domain for the name resolution request related to a domain in the first network as a response, when the name resolution for the name resolution request from the terminal device fails, the name resolution request is a request which is transmitted from the name resolving device to the information processing apparatus.
